(19) United States
(12) Patent Application Publication
(10) Pub. No.: US 2016/0012495 A1
(43) Pub. Date: Jan. 14, 2016

(54) SOLICITING CUSTOMER FEEDBACK BASED ON INDOOR POSITIONING SYSTEM DETECTION OF PHYSICAL CUSTOMER PRESENCE

(71) Applicant: Bank of America Corporation, Charlotte, NC (US)

(72) Inventors: Carrie Anne Hanson, Charlotte, NC (US); Don Cardinal, San Antonio, TX (US); David M. Grigg, Rock Hill, SC (US)

(21) Appl. No.: 14/327,560

(22) Filed: Jul. 10, 2014

(51) Int. Cl. G06Q 30/02; H04W 4/04

(52) U.S. Cl. CPC G06Q 30/0281; H04W 4/04

(57) ABSTRACT

A computing platform may receive a plurality of messages comprising data indicating physical presence of customers at a physical location from an indoor positioning system located at the physical location. The computing platform may determine that one or more customers of the customers at the physical location have left the physical location based on at least a portion of the data indicating the physical presence of the customers at the physical location. Responsive to determining that the one or more customers of the customers at the physical location have left the physical location, the computing platform may generate one or more messages soliciting feedback from the one or more customers regarding their experience at the physical location.

BACKGROUND

For most organizations, delivering prompt, high-quality customer service is of paramount importance. Customers that have poor experiences frequently become frustrated, and may opt to do business with a competitor, become frustrated more easily in the future, or the like. Many organizations recognize these phenomena, and attempt to continually improve their customer service by soliciting customer feedback (e.g., via reviews, surveys, forums, and the like). An ideal time for an organization to solicit customer feedback is contemporaneous to a customer's interaction with one or more representatives of the organization in the in-person context, for example, shortly after the customer was physically present at a location of the organization and interacted with representatives of the organization. Accordingly, a need exists for soliciting customer feedback based on indoor positioning system detection of physical customer presence.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

[03] In accordance with one or more embodiments, a computing platform may receive a plurality of messages comprising data indicating physical presence of customers of a financial institution at a physical banking center location of the financial institution from an indoor positioning system located at the physical banking center location of the financial institution. The computing platform may determine that one or more customers of the customers of the financial institution at the physical banking center location of the financial institution have left the physical banking center location of the financial institution based on at least a portion of the data indicating the physical presence of the customers of the financial institution at the physical banking center location of the financial institution. Responsive to determining that the one or more customers of the customers of the financial institution at the physical banking center location of the financial institution have left the physical banking center location of the financial institution, the computing platform may generate one or more messages soliciting feedback from the one or more customers regarding their experience at the physical banking center location of the financial institution.

In some embodiments, the computing platform may identify one or more personal computing devices presently in possession of the one or more customers based on at least one of the plurality of messages comprising the data indicating the physical presence of the customers of the financial institution at the physical banking center location of the financial institution. In such embodiments, the computing platform may communicate the one or more messages soliciting feedback from the one or more customers regarding their experience at the physical banking center location of the financial institution to the one or more personal computing devices presently in possession of the one or more customers.

In some embodiments, subsequent to receiving the plurality of messages comprising the data indicating the physical presence of the customers of the financial institution at the physical banking center location of the financial institution, the computing platform may receive a plurality of messages comprising data indicating that a subset of the customers of the financial institution at the physical banking center location of the financial institution remain physically present at the physical banking center location of the financial institution from the indoor positioning system located at the physical banking center location of the financial institution. In such embodiments, determining that the one or more customers of the customers of the financial institution at the physical banking center location of the financial institution have left the physical banking center location of the financial institution may include determining that the one or more customers of the customers of the financial institution at the physical banking center location of the financial institution are not among the subset of the customers of the financial institution at the physical banking center location of the financial institution based on at least a portion of the data indicating that the subset of the customers of the financial institution at the physical banking center location of the financial institution remain physically present at the physical banking center location of the financial institution.

In some embodiments, the plurality of messages comprising the data indicating the physical presence of the customers of the financial institution at the physical banking center location of the financial institution may include a plurality of customer identifiers. Each customer identifier of the plurality of customer identifiers may identify a customer of the customers of the financial institution at the physical banking center location of the financial institution. Additionally or alternatively, the plurality of messages comprising the data indicating that the subset of the customers of the financial institution at the physical banking center location of the financial institution remain physically present at the physical banking center location of the financial institution may include a different plurality of customer identifiers. Each customer identifier of the different plurality of customer identifiers may identify a customer of the subset of the customers of the financial institution at the physical banking center location of the financial institution. In such embodiments, determining that the one or more customers of the customers of the financial institution at the physical banking center location of the financial institution is not among the subset of the customers of the financial institution at the physical banking center location of the financial institution may include identifying one or more customer identifiers associated with the one or more customers of the customers of the financial institution at the physical banking center location of the financial institution that is among the plurality of customer identifiers and not among the different plurality of customer identifiers.

In some embodiments, generating the one or more messages soliciting feedback from the one or more customers regarding their experience at the physical banking center location of the financial institution may include generating, for each customer of the one or more customers, a message indicating that the customer recently visited the physical banking center location of the financial institution.

In some embodiments, generating the message indicating that the customer recently visited the physical banking center location of the financial institution may include generating a message identifying an associate of the financial institution that works at the physical banking center location of the financial institution. Generating the message identifying the associate of the financial institution that works at the physical banking center location of the financial institution may include generating a message identifying one or more transactions the associate of the financial institution that works at the physical banking center location of the financial institution assisted the customer with during their recent visit to the physical banking center location of the financial institution. Additionally or alternatively, generating the message identifying the associate of the financial institution that works at the physical banking center location of the financial institution may include generating a message comprising contact information for the associate of the financial institution that works at the physical banking center location of the financial institution. In such embodiments, generating the message comprising the contact information for the associate of the financial institution that works at the physical banking center location of the financial institution may include generating a message comprising a user-invokable option to add the contact information for the associate of the financial institution that works at the physical banking center location of the financial institution to a contact list of the customer.

In some embodiments, generating the message indicating that the customer recently visited the physical banking center location of the financial institution may include generating a message comprising one or more user-input options for the customer to provide feedback regarding their experience at the physical banking center location of the financial institution. In such embodiments, generating the message comprising the one or more user-input options for the customer to provide feedback regarding their experience at the physical banking center location of the financial institution may include generating a message comprising an option for the customer to share the feedback regarding their experience at the physical banking center location of the financial institution with other customers of the financial institution and/or an option for the customer to share the feedback regarding their experience at the physical banking center location of the financial institution with representatives of the financial institution.

In some embodiments, generating the message indicating that the customer recently visited the physical banking center location of the financial institution may include generating a message comprising a user-invokable option to have a representative of the financial institution contact the customer regarding their experience at the physical banking center location of the financial institution.

In some embodiments, the computing platform may receive one or more messages comprising data indicating that at least one customer of the one or more customers of the customers of the financial institution at the physical banking center location of the financial institution has physically returned to the physical banking center location of the financial institution from the indoor positioning system located at the physical banking center location of the financial institution. In such embodiments, the computing platform may determine whether the at least one customer of the one or more customers of the customers of the financial institution at the physical banking center location of the financial institution had a positive experience at the physical banking center location of the financial institution during their previous visit to the physical banking center location of the financial institution based on feedback provided by the at least one customer of the one or more customers of the customers of the financial institution at the physical banking center location of the financial institution via at least one of the one or more messages soliciting feedback from the one or more customers regarding their experience at the physical banking center location of the financial institution.

Responsive to determining that the at least one customer of the one or more customers of the customers of the financial institution at the physical banking center location of the financial institution had a positive experience at the physical banking center location of the financial institution during their previous visit to the physical banking center location of the financial institution, the computing platform may generate a message indicating that the at least one customer of the one or more customers of the customers of the financial institution at the physical banking center location of the financial institution had a positive experience at the physical banking center location of the financial institution during their previous visit to the physical banking center location of the financial institution, and may communicate the message indicating that the at least one customer of the one or more customers of the customers of the financial institution at the physical banking center location of the financial institution had a positive experience at the physical banking center location of the financial institution during their previous visit to the physical banking center location of the financial institution to a computing device located at the physical banking center location of the financial institution.

Responsive to determining that the at least one customer of the one or more customers of the customers of the financial institution at the physical banking center location of the financial institution did not have a positive experience at the physical banking center location of the financial institution during their previous visit to the physical banking center location of the financial institution, the computing platform may generate a message indicating that the at least one customer of the one or more customers of the customers of the financial institution at the physical banking center location of the financial institution did not have a positive experience at the physical banking center location of the financial institution during their previous visit to the physical banking center location of the financial institution, and may communicate the message indicating that the at least one customer of the one or more customers of the customers of the financial institution at the physical banking center location of the financial institution did not have a positive experience at the physical banking center location of the financial institution during their previous visit to the physical banking center location of the financial institution to a computing device located at the physical banking center location of the financial institution.

In some embodiments, the indoor positioning system located at the physical banking center location of the financial institution may include a plurality of personal computing devices presently in possession of the customers of the financial institution at the physical banking center location of the financial institution, and at least one location beacon that is located at the physical banking center location of the financial institution and configured to emit a signal comprising an identifier associated with the physical banking center location. In such embodiments, receiving the plurality of messages comprising data indicating the physical presence of the customers of the financial institution at the physical banking center location of the financial institution may include receiving data comprising the identifier associated with the physical banking center location from the plurality of personal computing devices.

In some embodiments, the indoor positioning system located at the physical banking center location of the financial institution may include a location beacon that is located at a first location of the physical banking center location of the financial institution and configured to emit a signal comprising an identifier associated with the first location of the physical banking center location of the financial institution, and a location beacon that is located at a second location of the physical banking center location of the financial institution and configured to emit a signal comprising an identifier associated with the second location of the physical banking center location of the financial institution. In such embodiments, receiving the plurality of messages comprising the data indicating the physical presence of the customers of the financial institution at the physical banking center location of the financial institution may include receiving, from the indoor positioning system located at the physical banking center location of the financial institution, messages comprising data indicating physical presence of a portion of the customers of the financial institution at the first location of the physical banking center location of the financial institution, and messages comprising data indicating physical presence of a portion of the customers of the financial institution at the second location of the physical banking center location of the financial institution. Additionally or alternatively, determining that the one or more customers of the customers of the financial institution at the physical banking center location of the financial institution have left the physical banking center location of the financial institution may include determining that a customer of the portion of the customers of the financial institution at the first location of the physical banking center location of the financial institution has left the physical banking center location of the financial institution based on at least a portion of the data indicating the physical presence of the portion of the customers of the financial institution at the first location of the physical banking center location of the financial institution, and determining that a customer of the portion of the customers of the financial institution at the second location of the physical banking center location of the financial institution has left the physical banking center location of the financial institution based on at least a portion of the data indicating the physical presence of the portion of the customers of the financial institution at the second location of the physical banking center location of the financial institution. Additionally or alternatively, generating the one or more messages soliciting feedback from the one or more customers regarding their experience at the physical banking center location of the financial institution may include generating a message soliciting feedback from the customer of the portion of the customers of the financial institution at the first location of the physical banking center location of the financial institution regarding their experience at the physical banking center location of the financial institution, and generating a message soliciting feedback from the customer of the portion of the customers of the financial institution at the second location of the physical banking center location of the financial institution regarding their experience at the physical banking center location of the financial institution.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for soliciting customer feedback based on indoor positioning system detection of physical customer presence in accordance with one or more example embodiments;

FIGS. 4A, 4B, 4C, 4D, 4E, and 4F depict an illustrative event sequence for soliciting customer feedback based on indoor positioning system detection of physical customer presence in accordance with one or more example embodiments;

FIG. 5 depicts an example message for soliciting customer feedback based on indoor positioning system detection of physical customer presence in accordance with one or more example embodiments; and

FIG. 6 depicts an illustrative method for soliciting customer feedback based on indoor positioning system detection of physical customer presence in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

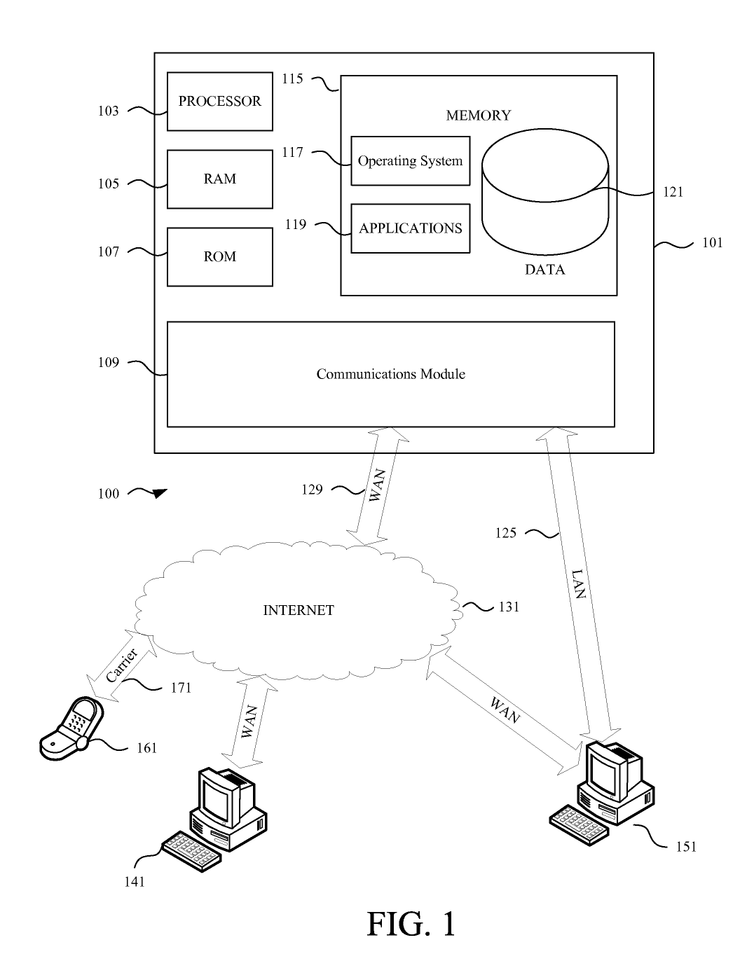

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

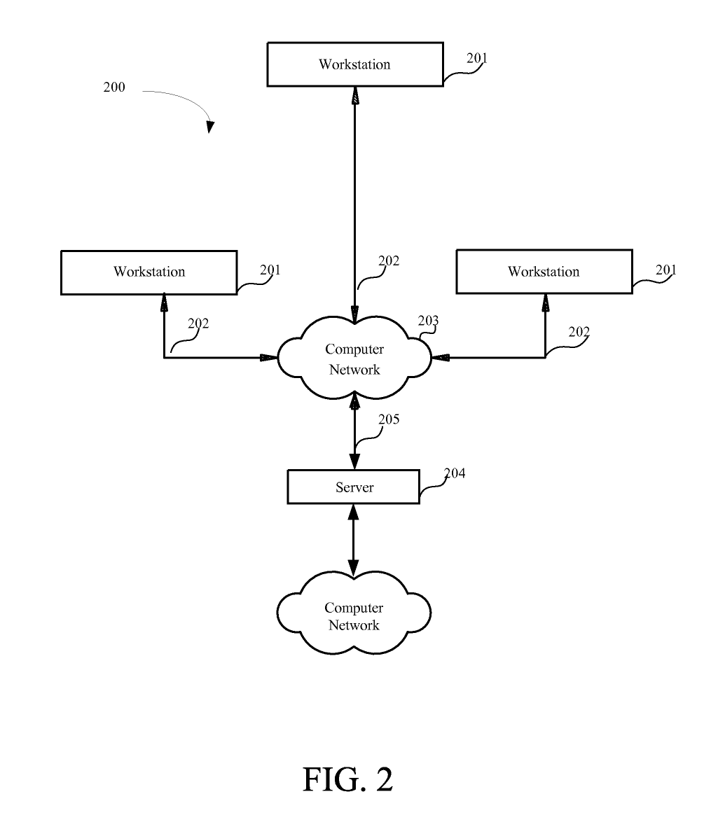

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

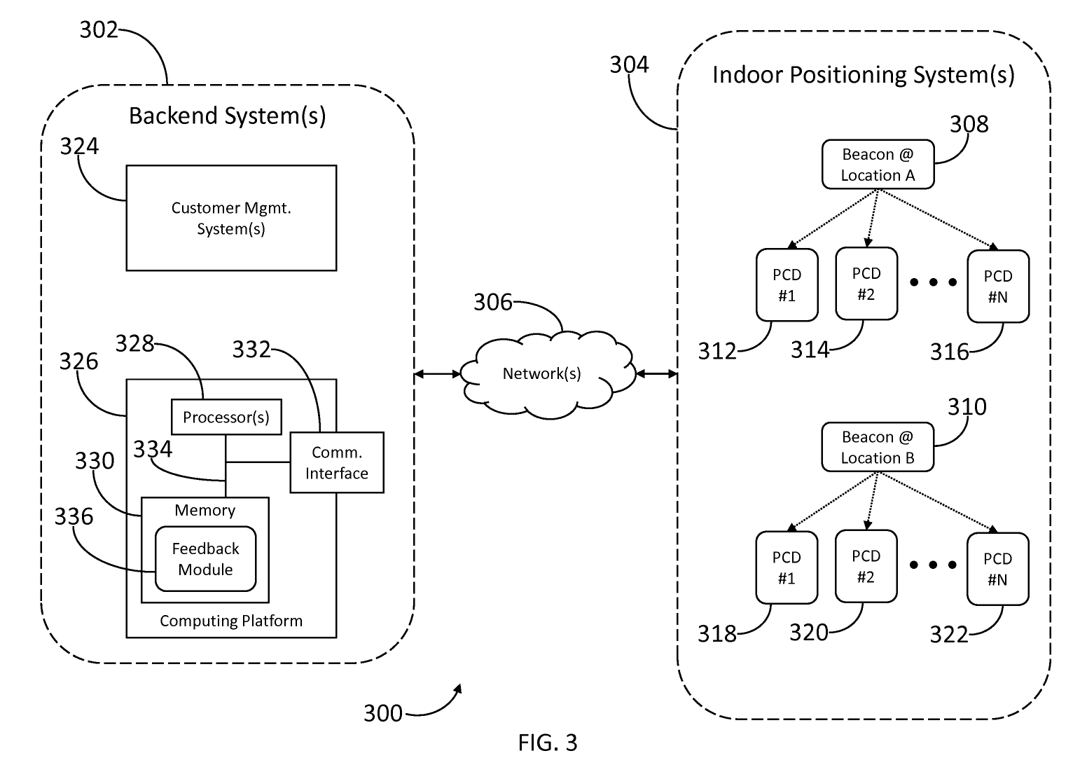

FIG. 3 depicts an illustrative computing environment for soliciting customer feedback based on indoor positioning system detection of physical customer presence in accordance with one or more example embodiments. Referring to FIG. 3, computing environment 300 may include one or more computing systems. For example, computing environment 300 may include backend computing system(s) 302 and indoor positioning system(s) 304. As will be described in greater detail below, backend computing system(s) 302 and/or indoor positioning system(s) 304 may include one or more computing devices associated with an organization (e.g., a financial institution). Indoor positioning system(s) 304 may be located at a particular physical location associated with the organization (e.g., a physical banking center location of the financial institution). In some embodiments, backend computing system(s) 302 may be located at a different geographic location from indoor positioning system(s) 304 (e.g., a central processing facility associated with the financial institution). Computing environment 300 may also include one or more networks. For example, computing environment 300 may include network(s) 306. Network(s) 306 may interconnect one or more computing devices of backend computing system(s) 302, and/or one or more computing devices of indoor positioning system(s) 304, and may include one or more sub-networks (e.g., LANs, WANs, or the like).

Indoor positioning system(s) 304 may include one or more location beacons configured to emit or broadcast a signal (e.g., a Bluetooth Low Energy signal, a Bluetooth Smart signal, a low-power radio signal, or the like) comprising an identifier associated with its physical location (e.g., a physical banking center location of the financial institution and/or a location within the physical banking center location of the financial institution). For example, indoor positioning system(s) 304 may include location beacon 308 and location beacon 310. Location beacon 308 may be configured to emit a signal comprising an identifier associated with its physical location (e.g., Location “A”), for example, an identifier associated with the physical banking center location of the financial institution and/or a location within the physical banking center location of the financial institution (e.g., an area associated with one or more human tellers, an area associated with one or more automated teller machines, an area associated with one or more loan officers, an area associated with one or more financial planners, an area associated with one or more customer service professionals, an area associated with an indoor lobby, an area associated with an outdoor lobby, an area associated with a walk-up or drive-up window, or the like). Similarly, location beacon 310 may be configured to emit a signal comprising an identifier associated with its physical location (e.g., Location “B”), for example, an identifier associated with the physical banking center location of the financial institution and/or a different location within the physical banking center location of the financial institution. Indoor positioning system(s) 304 may also include one or more personal computing devices, which may be presently in the possession of individuals (e.g., customers and/or associates of the financial institution) located at indoor positioning system(s) 304's physical location. For example, indoor positioning system(s) 304 may include personal computing devices 312 and 314 through 316, and personal computing devices 318 and 320 through 322.

Personal computing devices 312 and 314 through 316, and/or personal computing devices 318 and 320 through 322 may be any type of computing device capable of detecting the signal(s) emitted or broadcast by location beacon 308 and/or location beacon 310, generating a messaging indicating detection of the signal(s), and communicating the message indicating detection of the signal(s) to one or more other computing devices. For example, personal computing devices 312 and 314 through 316, and/or personal computing devices 318 and 320 through 322 may include one or more laptop computers, tablet computers, smart phones, mobile devices, near field communication tags, or the like. As will be described in greater detail below, when located within a proximity (e.g., zero to one hundred meters) of location beacon 308 and/or location beacon 310, personal computing devices 312 and 314 through 316, and/or personal computing devices 318 and 320 through 322 may be configured to detect signal(s) emitted by location beacon 308 and/or location beacon 310. Responsive to detecting signal(s) emitted by location beacon 308 and/or location beacon 310, personal computing devices 312 and 314 through 316, and/or personal computing devices 318 and 320 through 322 may be configured to generate a message indicating detection of the signal(s), and communicate the message to one or more other computing devices (e.g., one or more computing devices of backend computing system(s) 302). As indicated above, the signal(s) emitted by location beacon 308 and/or location beacon 310 may comprise one or more identifiers associated with their respective locations (e.g., Location “A,” Location “B,” or the like), and the message(s) generated by personal computing devices 312 and 314 through 316, and/or personal computing devices 318 and 320 through 322 responsive to detection of the signal(s) may comprise the identifier(s) and/or information identified utilizing the identifier(s) (e.g., information associated with Location “A,” Location “B,” or the like). Additionally or alternatively, the message(s) generated by personal computing devices 312 and 314 through 316, and/or personal computing devices 318 and 320 through 322 responsive to detection of the signal(s) may comprise identifiers associated with an individual presently in possession of one or more of personal computing devices 312 and 314 through 316, and/or personal computing devices 318 and 320 through 322, for example, customer identifier(s), associate identifier(s), or the like.

Backend computing system(s) 302 may include one or more computing devices associated with the organization (e.g., the financial institution). For example, backend computing system(s) 302 may include customer management system(s) 324 and computing platform 326. As will be described in greater detail below, customer management system(s) 324 may include one or more computing devices (e.g., mainframes, servers, server blades, or the like) configured to maintain information regarding customers of the organization (e.g., feedback received from the customers). Computing platform 326 may include one or more processor(s) 328, memory 330, communication interface 332, and data bus 334. Data bus 334 may interconnect processor(s) 328, memory 330, and/or communication interface 332. Communication interface 332 may be a network interface configured to support communications between computing platform 326 and network(s) 306, or one or more sub-networks thereof. Memory 330 may include one or more program modules comprising instructions that when executed by processor(s) 328 cause computing platform 326 to perform one or more functions described herein. For example, memory 330 may include feedback module 336, which may comprise instructions that when executed by processor(s) 328 may cause computing platform 326 to perform one or more functions described herein.

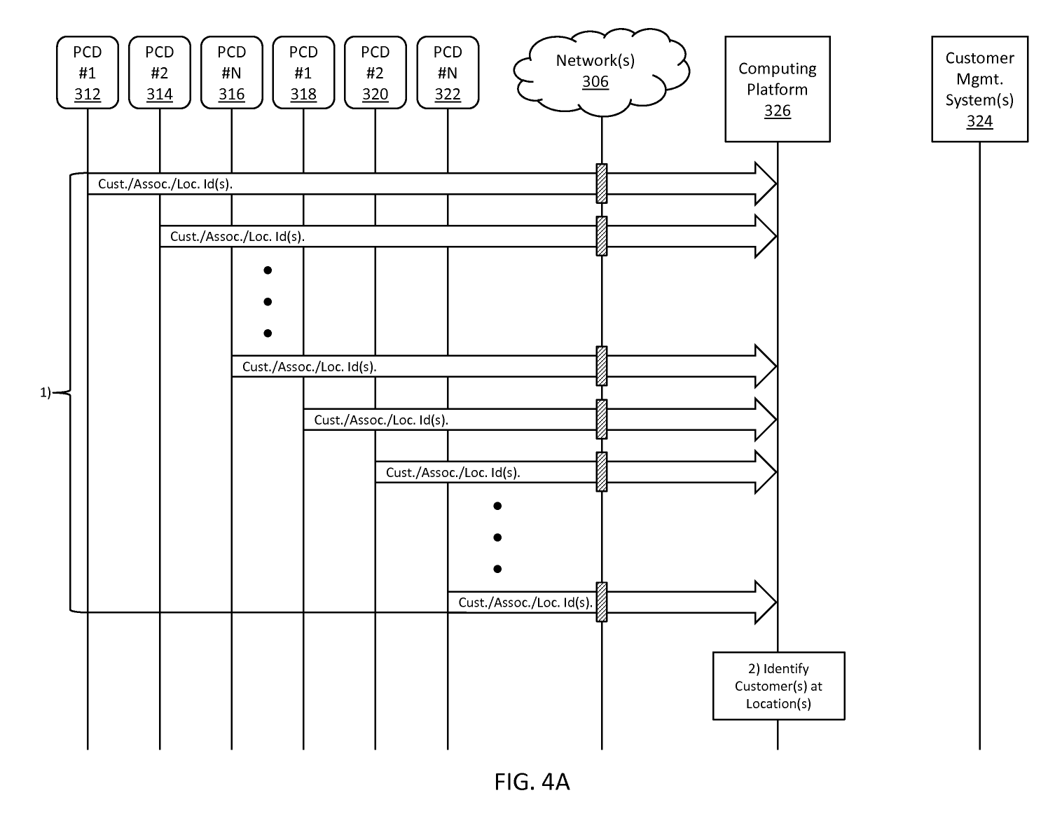

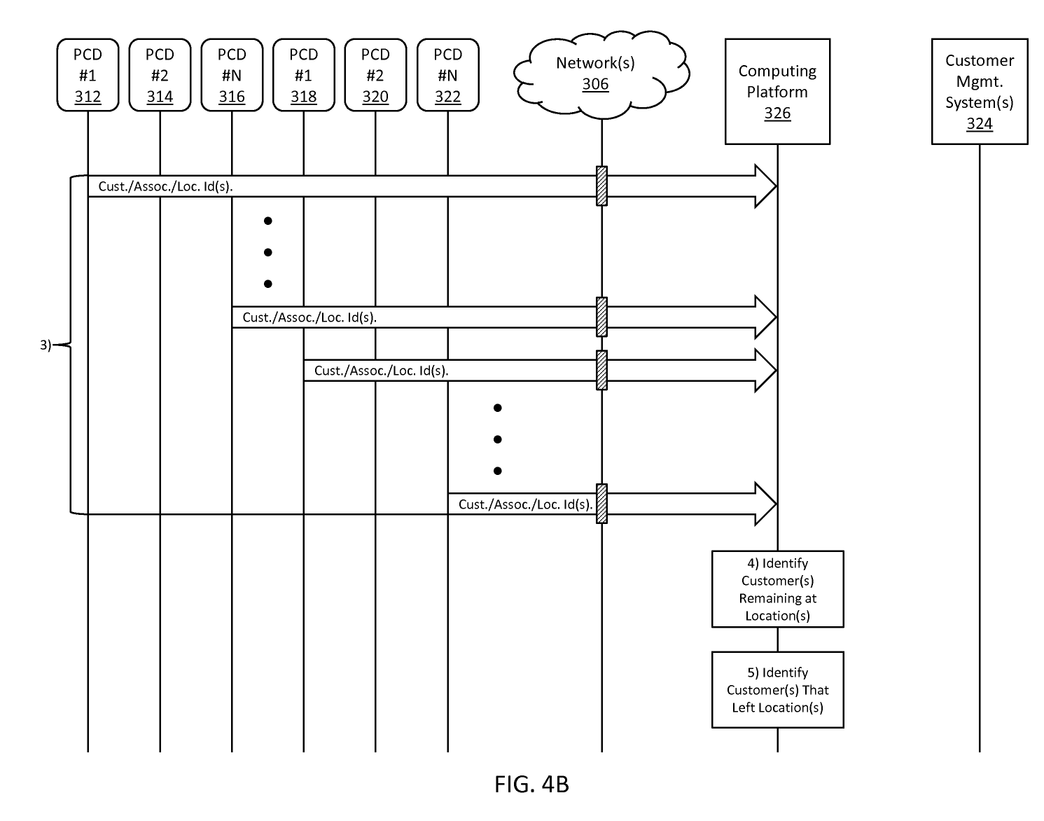

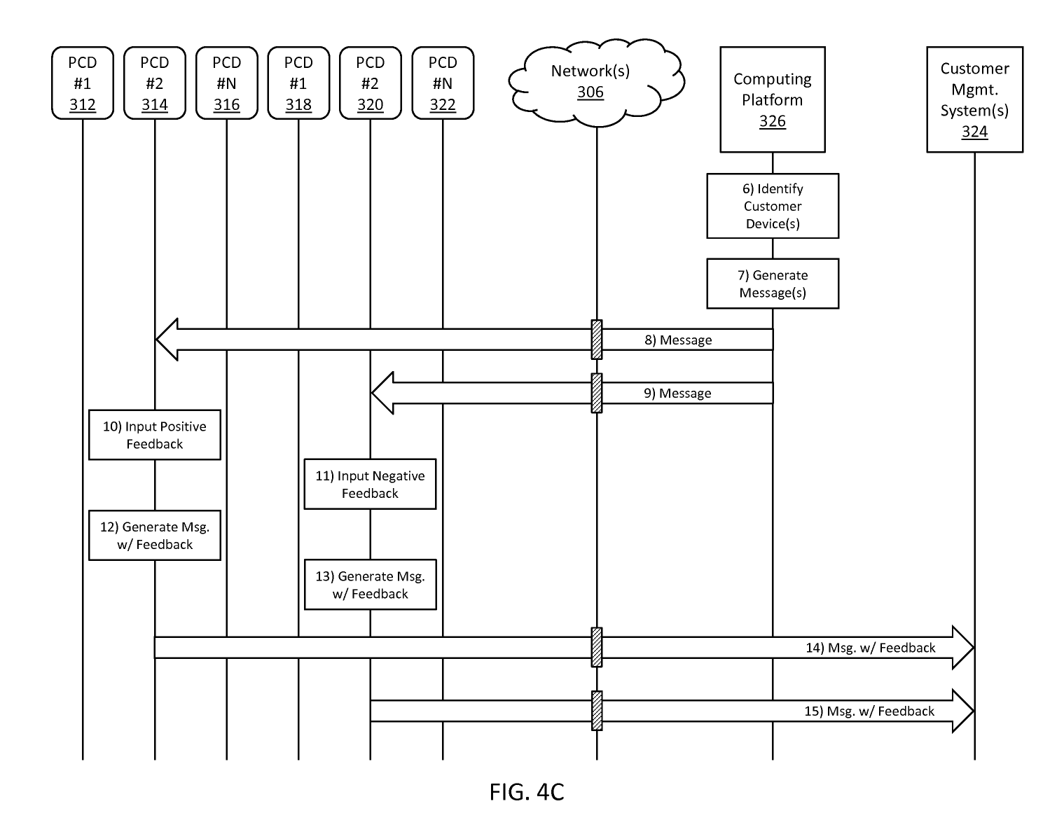

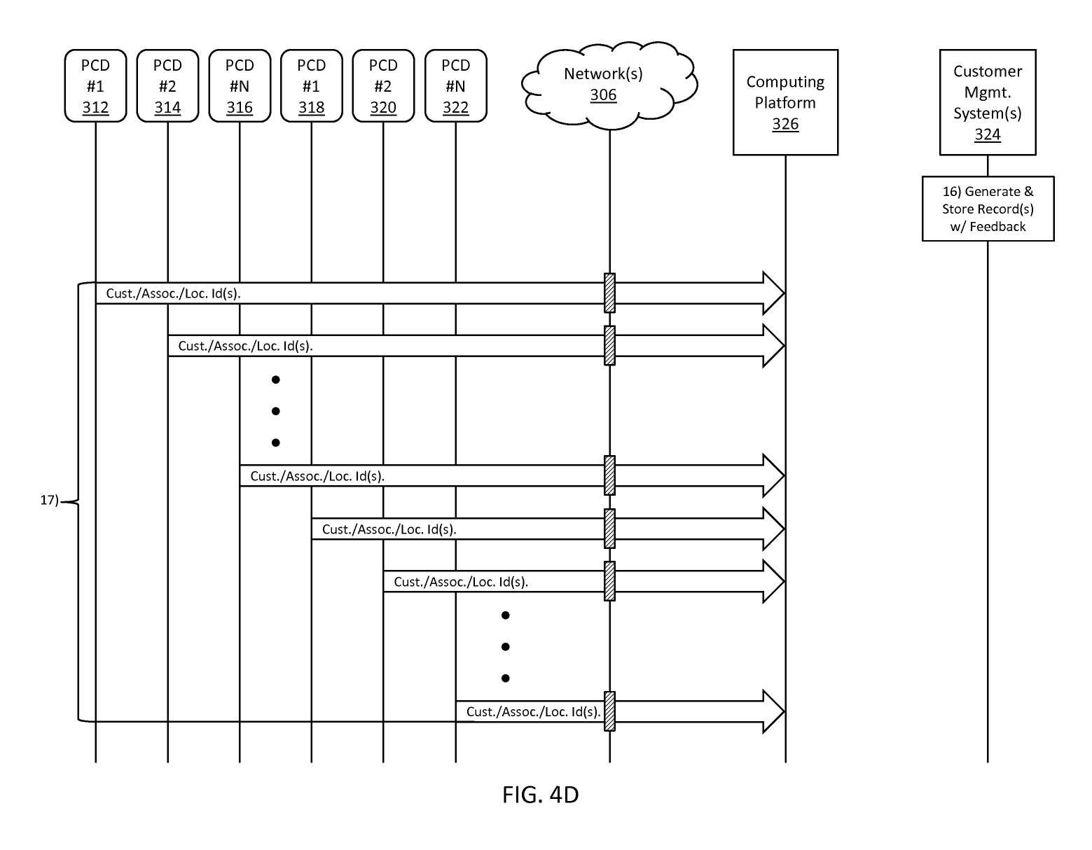

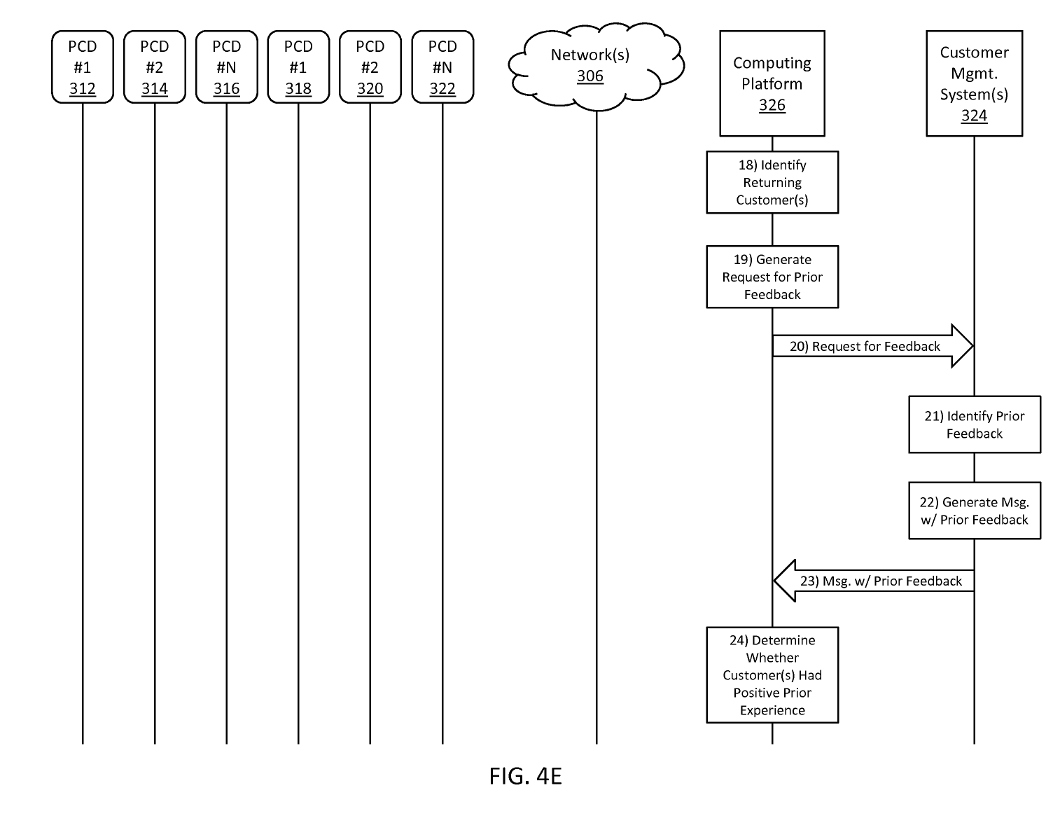

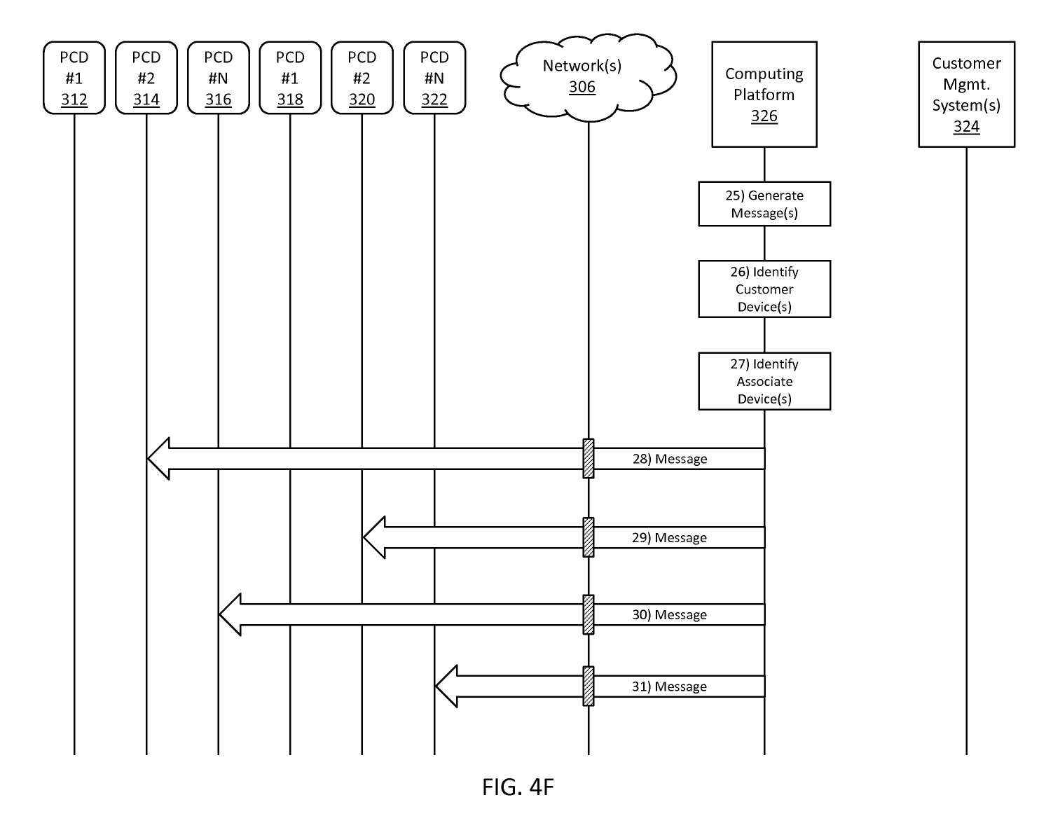

FIGS. 4A, 4B, 4C, 4D, 4E, and 4F depict an illustrative event sequence for soliciting customer feedback based on indoor positioning system detection of physical customer presence in accordance with one or more example embodiments. Referring to FIG. 4A, at step 1, computing platform 326 may receive (e.g., via communication interface 332 and network(s) 306) a plurality of messages comprising data indicating physical presence of individuals associated with an organization (e.g., customers and/or associates of a financial institution) at a physical location of the organization from indoor positioning system(s) 304 (e.g., an indoor positioning system located at a physical banking center location of the financial institution). For example, individuals (e.g., customers and/or associates of the financial institution) presently in possession of personal computing devices 312 and 314 through 316 may be located within a predetermined proximity of location beacon 308 (e.g., at Location “A”), and personal computing devices 312 and 314 through 316 may detect a signal emitted by location beacon 308 comprising an identifier associated with its location, and, responsive to detecting the signal, may generate and communicate to computing platform 326 (e.g., via network(s) 306) one or more messages indicating their physical presence within the proximity of location beacon 308. Similarly, individuals (e.g., customers and/or associates of the financial institution) presently in possession of personal computing devices 318 and 320 through 322 may be located within a predetermined proximity of location beacon 310 (e.g., at Location “B”), and personal computing devices 318 and 320 through 322 may detect a signal emitted by location beacon 310 comprising an identifier associated with its location, and, responsive to detecting the signal, may generate and communicate to computing platform 326 (e.g., via network(s) 306) one or more messages indicating their physical presence within the proximity of location beacon 310.

In some embodiments, each of the plurality of messages may include an identifier associated with the location (e.g., the identifier contained in the signal emitted by location beacon 308 and/or location beacon 310, information identified utilizing the identifier(s), or the like) and/or one or more identifiers associated with an individual (e.g., an associate or customer of the financial institution) presently in possession of the personal computing device that generated the message. For example, a message received from personal computing device 312 may comprise an identifier associated with Location “A” and/or an identifier associated with an individual presently in possession of personal computing device 312 (e.g., at Location “A”). Similarly, a message received from personal computing device 314 may comprise an identifier associated with Location “A” and/or an identifier associated with an individual presently in possession of personal computing device 314 (e.g., at Location “A”); a message received from personal computing device 316 may comprise an identifier associated with Location “A” and/or an identifier associated with an individual presently in possession of personal computing device 316 (e.g., at Location “A”); a message received from personal computing device 318 may comprise an identifier associated with Location “B” and/or an identifier associated with an individual presently in possession of personal computing device 318 (e.g., at Location “B”); a message received from personal computing device 320 may comprise an identifier associated with Location “B” and/or an identifier associated with an individual presently in possession of personal computing device 320 (e.g., at Location “B”); and a message received from personal computing device 322 may comprise an identifier associated with Location “B” and/or an identifier associated with an individual presently in possession of personal computing device 322 (e.g., at Location “B”).

At step 2, computing platform 326 may identify a plurality of customers physically present at the location(s) associated with indoor positioning system(s) 304 based on at least a portion of the data indicating the physical presence of individuals at the physical location(s) associated with indoor positioning system(s) 304. For example, personal computing device 312 may be presently in possession of a customer physically located at Location “A,” the message received from personal computing device 312 (e.g., in step 1 above) may include an identifier associated with the customer presently in possession of personal computing device 312 at Location “A,” and computing platform 326 may identify the customer presently in possession of personal computing device 312 at Location “A” based on the identifier associated with the customer presently in possession of personal computing device 312 at Location “A.” Similarly, personal computing device 314 may be presently in possession of a customer physically located at Location “A,” the message received from personal computing device 314 (e.g., in step 1 above) may include an identifier associated with the customer presently in possession of personal computing device 314 at Location “A,” and computing platform 326 may identify the customer presently in possession of personal computing device 314 at Location “A” based on the identifier associated with the customer presently in possession of personal computing device 314 at Location “A”; personal computing device 318 may be presently in possession of a customer physically located at Location “B,” the message received from personal computing device 318 (e.g., in step 1 above) may include an identifier associated with the customer presently in possession of personal computing device 318 at Location “B,” and computing platform 326 may identify the customer presently in possession of personal computing device 318 at Location “B” based on the identifier associated with the customer presently in possession of personal computing device 318 at Location “B”; and personal computing device 320 may be presently in possession of a customer physically located at Location “B,” the message received from personal computing device 320 (e.g., in step 1 above) may include an identifier associated with the customer presently in possession of personal computing device 320 at Location “B,” and computing platform 326 may identify the customer presently in possession of personal computing device 320 at Location “B” based on the identifier associated with the customer presently in possession of personal computing device 320 at Location “B.”

Referring to FIG. 4B, at step 3, computing platform 326 may receive (e.g., via communication interface 332 and network(s) 306) a plurality of messages comprising data indicating that a subset of the customers at the physical location(s) associated with indoor positioning system(s) 304 remain physically present at the physical location(s) associated with indoor positioning system(s) 304 from indoor positioning system(s) 304. For example, computing platform 326 may receive (e.g., via communication interface 332 and network(s) 306) a message from personal computing device 312, indicating that the customer presently in possession of personal computing device 312 remains physically present at Location “A,” and a message from personal computing device 318, indicating that the customer presently in possession of personal computing device 318 remains physically present at Location “B.” At step 4, computing platform 326 may identify one or more customers among the subset of the customers at the physical location(s) associated with indoor positioning system(s) 304 that remain physically present at the physical location(s) associated with indoor positioning system(s) 304. For example, personal computing device 312 may remain presently in possession of a customer physically located at Location “A” (e.g., the same customer as in step 2 above), the message received from personal computing device 312 (e.g., in step 3 above) may include the identifier associated with the customer that remains presently in possession of personal computing device 312 at Location “A,” and computing platform 326 may identify the customer that remains presently in possession of personal computing device 312 at Location “A” based on the identifier associated with the customer that remains presently in possession of personal computing device 312 at Location “A.” Similarly, personal computing device 318 may remain presently in possession of a customer physically located at Location “B” (e.g., the same customer as in step 2 above), the message received from personal computing device 318 (e.g., in step 3 above) may include the identifier associated with the customer that remains presently in possession of personal computing device 318 at Location “B,” and computing platform 326 may identify the customer that remains presently in possession of personal computing device 318 at Location “B” based on the identifier associated with the customer that remains presently in possession of personal computing device 318 at Location “B.”

At step 5, computing platform 326 may identify one or more customers that have left the location(s) associated with indoor positioning system(s) 304 (e.g., between a time period in which the messages received in step 1 were received and a time period in which the messages received in step 3 were received). For example, computing platform 326 may determine that the customer presently in possession of personal computing device 314 and the customer presently in possession of personal computing device 320 have left Location “A” and Location “B,” respectively, by, for example, determining that the identifier associated with the customer presently in possession of personal computing device 314 (e.g., the identifier received in the message from personal computing device 314 in step 1 above) and the identifier associated with the customer presently in possession of personal computing device 320 (e.g., the identifier received in the message from personal computing device 320 in step 1 above) are not among one or more customer identifiers included in the plurality of messages comprising the data indicating that the subset of the customers at the physical location(s) associated with indoor positioning system(s) 304 remain physically present at the physical location(s) associated with indoor positioning system(s) 304 (e.g., the messages received from indoor positioning system(s) 304 in step 3 above).

Referring to FIG. 4C, at step 6, computing platform 326 may identify one or more personal computing devices presently in possession of the customer(s) determined to have left the location(s) associated with indoor positioning system(s) 304. For example, computing platform 326 may identify personal computing device 314 (e.g., based on the message received from personal computing device 314 in step 1 above). Similarly, computing platform 326 may identify personal computing device 320 (e.g., based on the message received from personal computing device 320 in step 1 above). At step 7, computing platform 326 may generate one or more messages soliciting feedback from the customer(s) determined to have left the location(s) associated with indoor positioning system(s) 304 regarding their experience at the location(s) associated with indoor positioning system(s) 304. For example, computing platform 326 may generate a message soliciting feedback from the customer presently in possession of personal computing device 314 regarding his or her experience at Location “A.” Similarly, computing platform 326 may generate a message soliciting feedback from the customer presently in possession of personal computing device 320 regarding his or her experience at Location “B.”

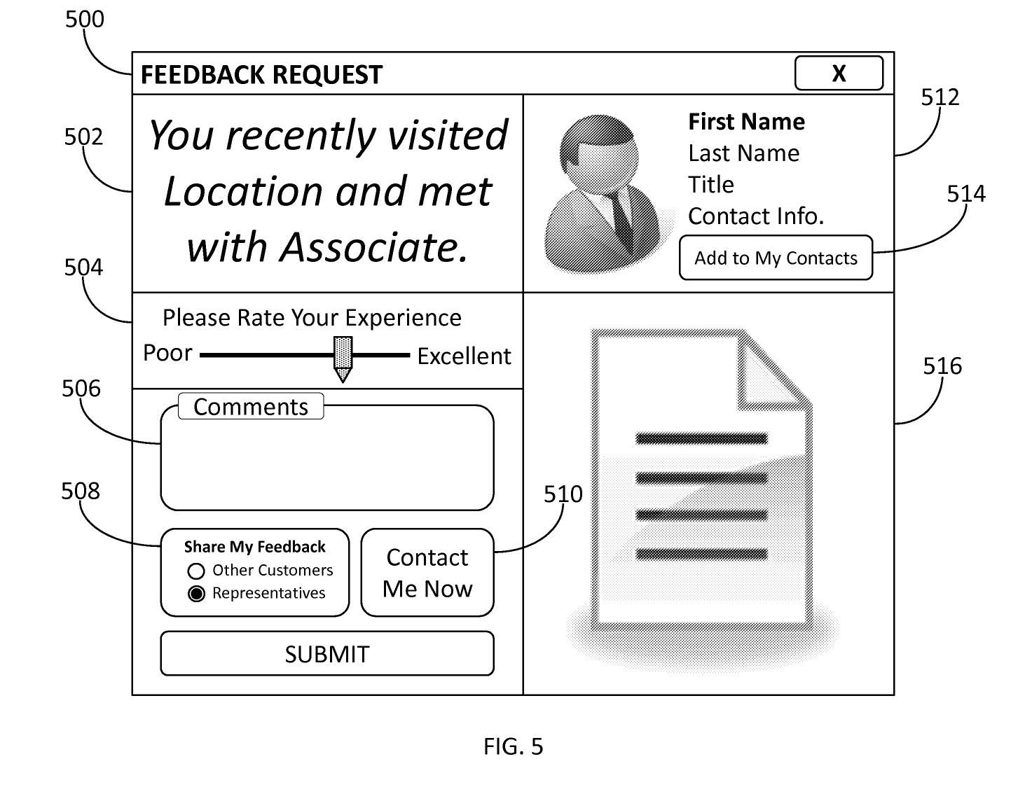

FIG. 5 depicts an example message for soliciting customer feedback based on indoor positioning system detection of physical customer presence in accordance with one or more example embodiments. Referring to FIG. 5, message 500 may include section 502, which may indicate that the customer (e.g., the customer presently in possession of personal computing device 314 or the customer presently in possession of personal computing device 320) recently visited location(s) associated with indoor positioning system(s) 304. Message 500 may also include one or more user-input options for the customer to provide feedback regarding their experience at the location(s) associated with indoor positioning system(s) 304. For example, message 500 may include user-input option 504 for the customer to rate their experience at the location(s) associated with indoor positioning system(s) 304, and user-input option 506 for the customer to provide comments regarding their experience at the location(s) associated with indoor positioning system(s) 304. Message 500 may further include user-input options 508 for the customer to share their feedback regarding their experience at the location(s) associated with indoor positioning system(s) 304 with other customers and/or representatives of the organization associated with indoor positioning system(s) 304. Message 500 may further include user-invokable option 510, which the customer may invoke to have a representative of the financial institution contact the customer regarding their experience at the location(s) associated with indoor positioning system(s) 304 (e.g., via a personal computing device presently in possession of the customer). Message 500 may also include section 512, which may identify an associate that works at the location(s) associated with indoor positioning system(s) 304, and/or contact information for the associate that works at the location(s) associated with indoor positioning system(s) 304. Message 500 may further include user-invokable option 514, which the customer may invoke to add the contact information for the associate that works at the location(s) associated with indoor positioning system(s) 304 to a contact list of the customer (e.g., a contact list associated with a personal computing device presently in possession of the customer). Message 500 may further include section 516, which may identify one or more transactions the associate that works at the location(s) associated with indoor positioning system(s) 304 assisted the customer with during their recent visit to the location(s) associated with indoor positioning system(s) 304.

Returning to FIG. 4C, at step 8, computing platform 326 may communicate (e.g., via communication interface 332 and network(s) 306) the message soliciting feedback from the customer presently in possession of personal computing device 314 regarding his or her experience at Location “A” to personal computing device 314. At step 9, computing platform 326 may communicate (e.g., via communication interface 332 and network(s) 306) the message soliciting feedback from the customer presently in possession of personal computing device 320 regarding his or her experience at Location “B” to personal computing device 320. The customer presently in possession of personal computing device 314 may receive the message soliciting feedback regarding his or her experience at Location “A,” and, at step 10, may provide feedback regarding his or her experience at Location “A” via the message (e.g., via user-input option 504 and/or user-input option 506). For example, the customer presently in possession of personal computing device 314 may utilize the message soliciting feedback regarding his or her experience at Location “A” to input positive feedback regarding his or her experience at Location “A.” Similarly, the customer presently in possession of personal computing device 320 may receive the message soliciting feedback regarding his or her experience at Location “B,” and, at step 11, may provide feedback regarding his or her experience at Location “B” via the message (e.g., via user-input option 504 and/or user-input option 506). For example, the customer presently in possession of personal computing device 320 may utilize the message soliciting feedback regarding his or her experience at Location “B” to input negative feedback regarding his or her experience at Location “B.”

At step 12, personal computing device 314 may generate a message comprising the customer presently in possession of personal computing device 314's feedback (e.g., the positive feedback) regarding his or her experience at Location “A.” At step 13, personal computing device 320 may generate a message comprising the customer presently in possession of personal computing device 320's feedback (e.g., the negative feedback) regarding his or her experience at Location “B.” At step 14, personal computing device 314 may communicate (e.g., via network(s) 306) the message comprising feedback regarding his or her experience at Location “A” to one or more computing devices of customer management system(s) 324. At step 15, personal computing device 320 may communicate (e.g., via network(s) 306) the message comprising feedback regarding his or her experience at Location “B” to one or more computing devices of customer management system(s) 324. The computing device(s) of customer management system(s) 324 may receive the message comprising the customer presently in possession of personal computing device 314's feedback regarding his or her experience at Location “A” from personal computing device 314 and the message comprising the customer presently in possession of personal computing device 320′s feedback regarding his or her experience at Location “B” from personal computing device 320, and, referring to FIG. 4D, at step 16, may generate and store one or more records comprising the customer presently in possession of personal computing device 314's feedback regarding his or her experience at Location “A” and the customer presently in possession of personal computing device 320's feedback regarding his or her experience at Location “B.”

At step 17, computing platform 326 may receive (e.g., via communication interface 332 and network(s) 306) one or more messages comprising data indicating that at least one customer that has previously visited the location(s) associated with indoor positioning system(s) 304 has physically returned to the location(s) associated with indoor positioning system(s) 304 from indoor positioning system(s) 304. For example, computing platform 326 may receive (e.g., via communication interface 332 and network(s) 306), inter alia, a message from personal computing device 314 comprising data (e.g., an identifier associated with the customer presently in possession of personal computing device 314 and/or an identifier associated with Location “A”) indicating that the customer presently in possession of personal computing device 314 has returned to Location “A,” and a message from personal computing device 320 comprising data (e.g., an identifier associated with the customer presently in possession of personal computing device 320 and/or an identifier associated with Location “B”) indicating that the customer presently in possession of personal computing device 320 has returned to Location “B.” Referring to FIG. 4E, at step 18, computing platform 326 may identify the customer(s) that have previously visited the location(s) associated with indoor positioning system(s) 304. For example, computing platform 326 may identify the customer presently in possession of personal computing device 314 based on the message received from personal computing device 314 in step 17 above (e.g., the identifier associated with the customer presently in possession of personal computing device 314). Similarly, computing platform 326 may identify the customer presently in possession of personal computing device 320 based on the message received from personal computing device 320 in step 17 above (e.g., the identifier associated with the customer presently in possession of personal computing device 320).

At step 19, computing platform 326 may generate a request for prior feedback that the customer(s) that have previously visited the location(s) associated with indoor positioning system(s) 304 have provided regarding their experience(s) at the location(s) associated with indoor positioning system(s) 304. For example, computing platform 326 may generate a request for the feedback provided by the customer presently in possession of personal computing device 314 regarding his or her experience at Location “A,” and the feedback provided by the customer presently in possession of personal computing device 320 regarding his or her experience at Location “B.” At step 20, computing platform 326 may communicate (e.g., via communication interface 332) the request for prior feedback that the customer(s) that have previously visited the location(s) associated with indoor positioning system(s) 304 have provided regarding their experience(s) at the location(s) associated with indoor positioning system(s) 304 to one or more computing devices of customer management system(s) 324. For example, computing platform 326 may communicate (e.g., via communication interface 332) the request for the feedback provided by the customer presently in possession of personal computing device 314 regarding his or her experience at Location “A,” and the feedback provided by the customer presently in possession of personal computing device 320 regarding his or her experience at Location “B” to the computing device(s) of customer management system(s) 324.

At step 21, the computing device(s) of customer management system(s) 324 may identify the requested prior feedback that the customer(s) that have previously visited the location(s) associated with indoor positioning system(s) 304 have provided regarding their experience(s) at the location(s) associated with indoor positioning system(s) 304. For example, the computing device(s) of customer management system(s) 324 may identify the feedback provided by the customer presently in possession of personal computing device 314 regarding his or her experience at Location “A,” and the feedback provided by the customer presently in possession of personal computing device 320 regarding his or her experience at Location “B” (e.g., by utilizing the record(s) generated and stored in step 16 above). At step 22, the computing device(s) of customer management system(s) 324 may generate a message comprising the identified prior feedback that the customer(s) that have previously visited the location(s) associated with indoor positioning system(s) 304 have provided regarding their experience(s) at the location(s) associated with indoor positioning system(s) 304. For example, the computing device(s) of customer management system(s) 324 may generate a message comprising the feedback provided by the customer presently in possession of personal computing device 314 regarding his or her experience at Location “A,” and the feedback provided by the customer presently in possession of personal computing device 320 regarding his or her experience at Location “B.” At step 23, the computing device(s) of customer management system(s) 324 may communicate the message comprising the feedback provided by the customer presently in possession of personal computing device 314 regarding his or her experience at Location “A,” and the feedback provided by the customer presently in possession of personal computing device 320 regarding his or her experience at Location “B” to computing platform 326, which may receive the message (e.g., via communication interface 332).

At step 24, computing platform 326 may determine whether the customer(s) that have previously visited the location(s) associated with indoor positioning system(s) 304 had a positive experience at the location(s) associated with indoor positioning system(s) 304. For example, computing platform 326 may determine that the customer presently in possession of personal computing device 314 had a positive experience when he or she previously visited Location “A” based on the feedback previously provided by the customer presently in possession of personal computing device 314 regarding his or her experience at Location “A.” Similarly, computing platform 326 may determine that the customer presently in possession of personal computing device 320 did not have a positive experience when he or she previously visited Location “B” based on the feedback previously provided by the customer presently in possession of personal computing device 320 regarding his or her experience at Location “B.” Referring to FIG. 4F, at step 25, computing platform 326 may generate one or more messages indicating whether the customer(s) that have previously visited the location(s) associated with indoor positioning system(s) 304 had a positive experience at the location(s) associated with indoor positioning system(s) 304. For example, responsive to determining that the customer presently in possession of personal computing device 314 had a positive experience when he or she previously visited Location “A,” computing platform 326 may generate one or more messages indicating that the customer presently in possession of personal computing device 314 had a positive experience when he or she previously visited Location “A.” Similarly, responsive to determining that the customer presently in possession of personal computing device 320 did not have a positive experience when he or she previously visited Location “B,” computing platform 326 may generate one or more messages indicating that the customer presently in possession of personal computing device 320 did not have a positive experience when he or she previously visited Location “B.”

At step 26, computing platform 326 may identify one or more personal computing devices presently in possession of the customer(s) that have returned to the location(s) associated with indoor positioning system(s) 304. For example, computing platform 326 may identify personal computing device 314 based on the message received from personal computing device 314 (e.g., in step 17 above). Similarly, computing platform 326 may identify personal computing device 320 based on the message received from personal computing device 320 (e.g., in step 17 above). At step 27, computing platform 326 may identify one or more personal computing devices presently in possession of associates located at the location(s) associated with indoor positioning system(s) 304 to which the customer(s) have returned. For example, computing platform 326 may determine that personal computing device 316 is presently in possession of an associate located at Location “A” (e.g., based on a message received from personal computing device 316 in step 17 above that included an associate identifier and/or an identifier associated with Location “A”). Similarly, computing platform 326 may determine that personal computing device 322 is presently in possession of an associate located at Location “B” (e.g., based on a message received from personal computing device 322 in step 17 above that included an associate identifier and/or an identifier associated with Location “B”).

At step 28, computing platform 326 may communicate (e.g., via communication interface 332 and network(s) 306) one or more of the message(s) indicating that the customer presently in possession of personal computing device 314 had a positive experience when he or she previously visited Location “A” to personal computing device 314 (e.g., to remind the customer of their previous positive experience, the associate that assisted them, or the like). At step 29, computing platform 326 may communicate (e.g., via communication interface 332 and network(s) 306) one or more of the message(s) indicating that the customer presently in possession of personal computing device 320 did not have a positive experience when he or she previously visited Location “B” to personal computing device 320 (e.g., to acknowledge that the customer did not previously have a positive experience, identify one or more offers to enhance this experience, identify an associate at the location that might be able to better assist them, or the like). At step 30, computing platform 326 may communicate (e.g., via communication interface 332 and network(s) 306) one or more of the message(s) indicating that the customer presently in possession of personal computing device 314 had a positive experience when he or she previously visited Location “A” to personal computing device 316 (e.g., to identify the customer to the associate, alert the associate that the customer had a previous positive experience, indicate that the associate should continue to develop the positive relationship, or the like). At step 31, computing platform 326 may communicate (e.g., via communication interface 332 and network(s) 306) one or more of the message(s) indicating that the customer presently in possession of personal computing device 320 did not have a positive experience when he or she previously visited Location “B” to personal computing device 322 (e.g., to identify the customer to the associate, acknowledge that the customer did not previously have a positive experience, identify one or more suggestions to enhance this experience, or the like).

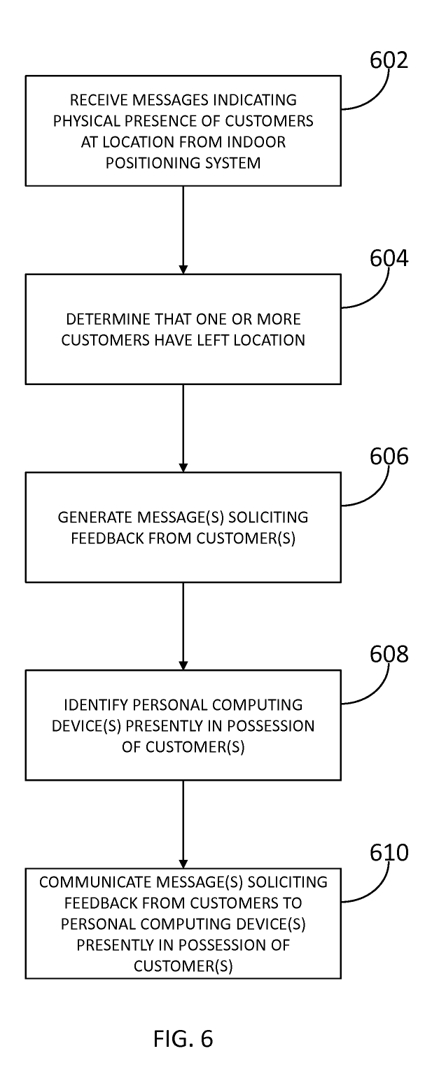

FIG. 6 depicts an illustrative method for soliciting customer feedback based on indoor positioning system detection of physical customer presence in accordance with one or more example embodiments. Referring to FIG. 6, at step 602, a computing platform may receive a plurality of messages comprising data indicating physical presence of customers at a physical location from an indoor positioning system located at the physical location. For example, computing platform 326 may receive a plurality of messages indicating the physical presence of the customer presently in possession of personal computing device 312, the customer presently in possession of personal computing device 314, the customer presently in possession of personal computing device 318, and the customer presently in possession of personal computing device 320, at the location(s) associated with indoor positioning system(s) 304 from indoor positioning system(s) 304. At step 604, the computing platform may determine that one or more of the customers at the physical location have left the physical location. For example, computing platform 326 may determine that the customer presently in possession of personal computing device 314 and the customer presently in possession of personal computing device 320 have left the location(s) associated with indoor positioning system(s) 304.

At step 606, responsive to determining that the customer(s) at the physical location have left the physical location, the computing platform may generate one or more messages soliciting feedback from the customer(s) regarding their experience at the physical location. For example, responsive to determining that the customer presently in possession of personal computing device 314 and the customer presently in possession of personal computing device 320 have left the location(s) associated with indoor positioning system(s) 304, computing platform 326 may generate one or more messages soliciting feedback from the customer presently in possession of personal computing device 314 and the customer presently in possession of personal computing device 320 regarding their experiences at the location(s) associated with indoor positioning system(s) 304. At step 608, the computing platform may identify one or more personal computing devices presently in possession of the customer(s) that have left the physical location. For example, computing platform 326 may identify personal computing device 314 and personal computing device 320. At step 610, the computing platform may communicate the message(s) soliciting feedback from the customer(s) regarding their experience at the physical location to the personal computing device(s) presently in possession of the customer(s) that have left the physical location. For example, computing platform 326 may communicate the message soliciting feedback from the customer presently in possession of personal computing device 314 regarding his or her experience at the location(s) associated with indoor positioning system(s) 304 to personal computing device 314, and may communicate the message soliciting feedback from the customer presently in possession of personal computing device 320 regarding his or her experience at the location(s) associated with indoor positioning system(s) 304 to personal computing device 320.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
receiving, via the communication interface and from an indoor positioning system located at a physical banking center location of a financial institution, a plurality of messages comprising data indicating physical presence of customers of the financial institution at the physical banking center location of the financial institution;
determining, by the at least one processor and based on at least a portion of the data indicating the physical presence of the customers of the financial institution at the physical banking center location of the financial institution, that one or more customers of the customers of the financial institution at the physical banking center location of the financial institution have left the physical banking center location of the financial institution; and
responsive to determining that the one or more customers of the customers of the financial institution at the physical banking center location of the financial institution have left the physical banking center location of the financial institution, generating, by the at least one processor, one or more messages soliciting feedback from the one or more customers regarding their experience at the physical banking center location of the financial institution.

2. The method of claim 1, comprising:
identifying, by the at least one processor and based on at least one of the plurality of messages comprising the data indicating the physical presence of the customers of the financial institution at the physical banking center location of the financial institution, one or more personal computing devices presently in possession of the one or more customers; and
communicating, via the communication interface and to the one or more personal computing devices presently in possession of the one or more customers, the one or more messages soliciting feedback from the one or more customers regarding their experience at the physical banking center location of the financial institution.

3. The method of claim 1, comprising subsequent to receiving the plurality of messages comprising the data indicating the physical presence of the customers of the financial institution at the physical banking center location of the financial institution, receiving, via the communication interface and from the indoor positioning system located at the physical banking center location of the financial institution, a plurality of messages comprising data indicating that a subset of the customers of the financial institution at the physical banking center location of the financial institution remain physically present at the physical banking center location of the financial institution.

4. The method of claim 3, wherein determining that the one or more customers of the customers of the financial institution at the physical banking center location of the financial institution have left the physical banking center location of the financial institution comprises determining, based on at least a portion of the data indicating that the subset of the customers of the financial institution at the physical banking center location of the financial institution remain physically present at the physical banking center location of the financial institution, that the one or more customers of the customers of the financial institution at the physical banking center location of the financial institution are not among the subset of the customers of the financial institution at the physical banking center location of the financial institution.

5. The method of claim 4, wherein the plurality of messages comprising the data indicating the physical presence of the customers of the financial institution at the physical banking center location of the financial institution comprises a plurality of customer identifiers, each customer identifier of the plurality of customer identifiers identifying a customer of the customers of the financial institution at the physical banking center location of the financial institution, and wherein the plurality of messages comprising the data indicating that the subset of the customers of the financial institution at the physical banking center location of the financial institution remain physically present at the physical banking center location of the financial institution comprises a different plurality of customer identifiers, each customer identifier of the different plurality of customer identifiers identifying a customer of the subset of the customers of the financial institution at the physical banking center location of the financial institution, and wherein determining that the one or more customers of the customers of the financial institution at the physical banking center location of the financial institution is not among the subset of the customers of the financial institution at the physical banking center location of the financial institution comprises identifying one or more customer identifiers associated with the one or more customers of the customers of the financial institution at the physical banking center location of the financial institution that is among the plurality of customer identifiers and not among the different plurality of customer identifiers.

6. The method of claim 1, wherein generating the one or more messages soliciting feedback from the one or more customers regarding their experience at the physical banking center location of the financial institution comprises generating, by the at least one processor, for each customer of the one or more customers, a message indicating that the customer recently visited the physical banking center location of the financial institution.

7. The method of claim 6, wherein generating the message indicating that the customer recently visited the physical banking center location of the financial institution comprises generating, by the at least one processor, a message identifying an associate of the financial institution that works at the physical banking center location of the financial institution.

8. The method of claim 7, wherein generating the message identifying the associate of the financial institution that works at the physical banking center location of the financial institution comprises generating, by the at least one processor, a message identifying one or more transactions the associate of the financial institution that works at the physical banking center location of the financial institution assisted the customer with during their recent visit to the physical banking center location of the financial institution.

9. The method of claim 7, wherein generating the message identifying the associate of the financial institution that works at the physical banking center location of the financial institution comprises generating, by the at least one processor, a message comprising contact information for the associate of the financial institution that works at the physical banking center location of the financial institution.

10. The method of claim 9, wherein generating the message comprising the contact information for the associate of the financial institution that works at the physical banking center location of the financial institution comprises, generating, by the at least one processor, a message comprising a user-invokable option to add the contact information for the associate of the financial institution that works at the physical banking center location of the financial institution to a contact list of the customer.

11. The method of claim 6, wherein generating the message indicating that the customer recently visited the physical banking center location of the financial institution comprises generating, by the at least one processor, a message comprising one or more user-input options for the customer to provide feedback regarding their experience at the physical banking center location of the financial institution.

12. The method of claim 11, wherein generating the message comprising the one or more user-input options for the customer to provide feedback regarding their experience at the physical banking center location of the financial institution comprises generating, by the at least one processor, a message comprising at least one of an option for the customer to share the feedback regarding their experience at the physical banking center location of the financial institution with other customers of the financial institution, or an option for the customer to share the feedback regarding their experience at the physical banking center location of the financial institution with representatives of the financial institution.

13. The method of claim 6, wherein generating the message indicating that the customer recently visited the physical banking center location of the financial institution comprises generating, by the at least one processor, a message comprising a user-invokable option to have a representative of the financial institution contact the customer regarding their experience at the physical banking center location of the financial institution.

14. The method of claim 1, comprising:
receiving, via the communication interface and from the indoor positioning system located at the physical banking center location of the financial institution, one or more messages comprising data indicating that at least one customer of the one or more customers of the customers of the financial institution at the physical banking center location of the financial institution has physically returned to the physical banking center location of the financial institution; and
determining, by the at least one processor and based on feedback provided by the at least one customer of the one or more customers of the customers of the financial institution at the physical banking center location of the financial institution via at least one of the one or more messages soliciting feedback from the one or more customers regarding their experience at the physical banking center location of the financial institution, whether the at least one customer of the one or more customers of the customers of the financial institution at the physical banking center location of the financial institution had a positive experience at the physical banking center location of the financial institution during their previous visit to the physical banking center location of the financial institution.

15. The method of claim 14, comprising:
responsive to determining that the at least one customer of the one or more customers of the customers of the financial institution at the physical banking center location of the financial institution had a positive experience at the physical banking center location of the financial institution during their previous visit to the physical banking center location of the financial institution:
generating, by the at least one processor, a message indicating that the at least one customer of the one or more customers of the customers of the financial institution at the physical banking center location of the financial institution had a positive experience at the physical banking center location of the financial institution during their previous visit to the physical banking center location of the financial institution; and
communicating, via the communication interface and to a computing device located at the physical banking center location of the financial institution, the message indicating that the at least one customer of the one or more customers of the customers of the financial institution at the physical banking center location of the financial institution had a positive experience at the physical banking center location of the financial institution during their previous visit to the physical banking center location of the financial institution.

16. The method of claim 14, comprising:
responsive to determining that the at least one customer of the one or more customers of the customers of the financial institution at the physical banking center location of the financial institution did not have a positive experience at the physical banking center location of the financial institution during their previous visit to the physical banking center location of the financial institution:
generating, by the at least one processor, a message indicating that the at least one customer of the one or more customers of the customers of the financial institution at the physical banking center location of the financial institution did not have a positive experience at the physical banking center location of the financial institution during their previous visit to the physical banking center location of the financial institution; and
communicating, via the communication interface and to a computing device located at the physical banking center location of the financial institution, the message indicating that the at least one customer of the one or more customers of the customers of the financial institution at the physical banking center location of the financial institution did not have a positive experience at the physical banking center location of the financial institution during their previous visit to the physical banking center location of the financial institution.

17. The method of claim 1, wherein:
the indoor positioning system located at the physical banking center location of the financial institution comprises:
a plurality of personal computing devices presently in possession of the customers of the financial institution at the physical banking center location of the financial institution, and
at least one location beacon that is located at the physical banking center location of the financial institution and configured to emit a signal comprising an identifier associated with the physical banking center location; and
receiving the plurality of messages comprising data indicating the physical presence of the customers of the financial institution at the physical banking center location of the financial institution comprises receiving, via the communication interface and from the plurality of personal computing devices, data comprising the identifier associated with the physical banking center location.

18. The method of claim 17, wherein:
the indoor positioning system located at the physical banking center location of the financial institution comprises:
a location beacon that is located at a first location of the physical banking center location of the financial institution and configured to emit a signal comprising an identifier associated with the first location of the physical banking center location of the financial institution, and
a location beacon that is located at a second location of the physical banking center location of the financial institution and configured to emit a signal comprising an identifier associated with the second location of the physical banking center location of the financial institution;
receiving the plurality of messages comprising the data indicating the physical presence of the customers of the financial institution at the physical banking center location of the financial institution comprises:
receiving, via the communication interface and from the indoor positioning system located at the physical banking center location of the financial institution, messages comprising data indicating physical presence of a portion of the customers of the financial institution at the first location of the physical banking center location of the financial institution, and
receiving, via the communication interface and from the indoor positioning system located at the physical banking center location of the financial institution, messages comprising data indicating physical presence of a portion of the customers of the financial institution at the second location of the physical banking center location of the financial institution;
determining that the one or more customers of the customers of the financial institution at the physical banking center location of the financial institution have left the physical banking center location of the financial institution comprises:
determining, by the at least one processor and based on at least a portion of the data indicating the physical presence of the portion of the customers of the financial institution at the first location of the physical banking center location of the financial institution, that a customer of the portion of the customers of the financial institution at the first location of the physical banking center location of the financial institution has left the physical banking center location of the financial institution, and
determining, by the at least one processor and based on at least a portion of the data indicating the physical presence of the portion of the customers of the financial institution at the second location of the physical banking center location of the financial institution, that a customer of the portion of the customers of the financial institution at the second location of the physical banking center location of the financial institution has left the physical banking center location of the financial institution; and
generating the one or more messages soliciting feedback from the one or more customers regarding their experience at the physical banking center location of the financial institution comprises:
generating, by the at least one processor, a message soliciting feedback from the customer of the portion of the customers of the financial institution at the first location of the physical banking center location of the financial institution regarding their experience at the physical banking center location of the financial institution, and
generating, by the at least one processor, a message soliciting feedback from the customer of the portion of the customers of the financial institution at the second location of the physical banking center location of the financial institution regarding their experience at the physical banking center location of the financial institution.

19. An apparatus, comprising:
at least one processor;
a communication interface; and
a memory storing instructions that when executed by the at least one processor cause the apparatus to:
receive, via the communication interface and from an indoor positioning system located at a physical banking center location of a financial institution, a plurality of messages comprising data indicating physical presence of customers of the financial institution at the physical banking center location of the financial institution;
determine, based on at least a portion of the data indicating the physical presence of the customers of the financial institution at the physical banking center location of the financial institution, that one or more customers of the customers of the financial institution at the physical banking center location of the financial institution have left the physical banking center location of the financial institution; and
responsive to determining that the one or more customers of the customers of the financial institution at the physical banking center location of the financial institution have left the physical banking center location of the financial institution:
generate one or more messages soliciting feedback from the one or more customers regarding their experience at the physical banking center location of the financial institution;
identify, based on at least one of the plurality of messages comprising the data indicating the physical presence of the customers of the financial institution at the physical banking center location of the financial institution, one or more personal computing devices presently in possession of the one or more customers; and
communicate, via the communication interface and to the one or more personal computing devices presently in possession of the one or more customers, the one or more messages soliciting feedback from the one or more customers regarding their experience at the physical banking center location of the financial institution.

20. One or more non-transitory computer-readable media having instructions stored thereon that when executed by one or more computers cause the one or more computers to:
receive, from an indoor positioning system located at a physical banking center location of a financial institution, a plurality of messages comprising data indicating physical presence of customers of the financial institution at the physical banking center location of the financial institution; and
responsive to receiving the plurality of messages comprising the data indicating the physical presence of the customers of the financial institution at the physical banking center location of the financial institution:
generate one or more messages soliciting feedback from one or more customers of the customers of the financial institution at the physical banking center location of the financial institution regarding their experience at the physical banking center location of the financial institution;
identify, based on at least one of the plurality of messages comprising the data indicating the physical presence of the customers of the financial institution at the physical banking center location of the financial institution, one or more personal computing devices presently in possession of the one or more customers of the customers of the financial institution at the physical banking center location of the financial institution; and
communicate, to the one or more personal computing devices presently in possession of the one or more customers of the customers of the financial institution at the physical banking center location of the financial institution, the one or more messages soliciting feedback from the one or more customers of the customers of the financial institution at the physical banking center location of the financial institution regarding their experience at the physical banking center location of the financial institution.
